(19) United States
(12) Patent Application Publication
(10) Pub. No.: US 2014/0365119 A1
(43) Pub. Date: Dec. 11, 2014

(54) DETECTING INFORMATION ABOUT MOTION OF MOBILE DEVICE

(71) Applicant: INDOORATLAS OY, Oulu (FI)

(72) Inventors: Janne Haverinen, Kiviniemi (FI); Jaakko Suutala, Oulu (FI); Mikko Perttunen, Oulu (FI)

(21) Appl. No.: 13/915,016

(22) Filed: Jun. 11, 2013

(51) Int. Cl. G01C 21/20

(52) U.S. Cl. CPC G01C 21/206
USPC 701/500

(57) ABSTRACT

Provided is an apparatus caused at least to: acquire a set of Earth's magnetic field, EMF, measurement results, wherein each EMF measurement result represents at least one of a magnitude and a direction of the EMF as experienced by a mobile device; perform, on the basis of the set of EMF measurement results, a first observation indicating that the mobile device is currently in motion; acquire a set of inertial measurement results, wherein each inertial measurement result represents at least one of acceleration and angular velocity experienced by the mobile device; perform, on the basis of the set of inertial measurement results, a second observation indicating that the motion of the mobile device does not exceed a predefined stationarity threshold; and determine, on the basis of the first and second observations, that the mobile device is currently located in a transport unit which is moving with respect to surrounding environment.

### FIELD

The invention relates generally to indoor positioning systems applying Earth's magnetic fields (EMF).

### BACKGROUND

It may be of importance to detect information about the environment of the person. Such information may indicate where the person currently is located. The information may indicate whether the person is in a moving environment, e.g. in a moving vehicle, or staying still. However, a well-known outdoor positioning system employing a global positioning system (GPS) or any other satellite based system may not work inside a building due to lack of reliable reception of satellite coverage. Therefore, a positioning technique utilizing Earth's magnetic fields (EMF) indoors has been developed as one possible option for indoor location discovery. This type of location discovery applies, for example, a magnetic field strength measured by a mobile device.

### BRIEF DESCRIPTION OF THE INVENTION

According to an aspect of the invention, there is provided an apparatus as specified in claim 1.

According to an aspect of the invention, there is provided a method, comprising: acquiring a set of Earth's magnetic field (EMF) measurement results, wherein each EMF measurement result represents at least one of a magnitude and a direction of the EMF as experienced by a mobile device; performing, on the basis of the set of EMF measurement results, a first observation indicating that the mobile device is currently in motion; acquiring a set of inertial measurement results, wherein each inertial measurement result represents at least one of acceleration and angular velocity experienced by the mobile device; performing, on the basis of the set of inertial measurement results, a second observation indicating that the motion of the mobile device does not exceed a predefined stationarity threshold; and determining, on the basis of the first and second observations, that the mobile device is currently located in a transport unit which is moving with respect to surrounding environment.

According to an aspect of the invention, there is provided a computer program product embodied on a distribution medium readable by a computer and comprising program instructions which, when loaded into an apparatus, execute at least the following: acquiring a set of Earth's magnetic field (EMF) measurement results, wherein each EMF measurement result represents at least one of a magnitude and a direction of the EMF as experienced by a mobile device; performing, on the basis of the set of EMF measurement results, a first observation indicating that the mobile device is currently in motion; acquiring a set of inertial measurement results, wherein each inertial measurement result represents at least one of acceleration and angular velocity experienced by the mobile device; performing, on the basis of the set of inertial measurement results, a second observation indicating that the motion of the mobile device does not exceed a predefined stationarity threshold; and determining, on the basis of the first and second observations, that the mobile device is currently located in a transport unit which is moving with respect to surrounding environment.

According to an aspect of the invention, there is provided a computer-readable distribution medium carrying the above-mentioned computer program product.

According to an aspect of the invention, there is provided an apparatus comprising means for performing the embodiments as described in the description.

Embodiments of the invention are defined in the dependent claims.

### LIST OF DRAWINGS

In the following, the invention will be described in greater detail with reference to the embodiments and the accompanying drawings, in which

FIG. 1 presents a floor plan of a building;

FIG. 2 shows an example of measured magnetic field vector;

FIG. 3A shows a method according to an embodiment;

FIG. 3B show a mobile device locating in a transport unit;

FIGS. 4A to 4C show possible movements of the mobile device on the basis of inertial data, according to some embodiments;

FIG. 5 shows a method according to an embodiment;

FIGS. 6A to 6E show some embodiments for determining the type of the transport unit;

FIG. 7 shows an embodiment related to a case in which the mobile device is in an elevator, according to an embodiment;

FIG. 8 shows an embodiment related to a case in which the mobile device is in an underground subway, according to an embodiment;

FIG. 9 depicts methods according to some embodiments; and

FIGS. 10 and 11 illustrate apparatuses according to some embodiments.

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In order to enable positioning, a GPS based location discovery and/or tracking is known. The GPS location discovery may not, however, be suitable for indoors due to lack of satellite reception coverage. For indoor based location tracking, RF based location discovery and location tracking may be used. In such system, a round trip time of the RF signal, or the power of the received RF signal, for example, may be determined to an indoor base station to which the user device is connected to. Some other known positioning measures, which may be applicable indoors, include machine vision, motion sensor and distance measuring, for example. However, these may require expensive measuring devices and equipment mounted throughout the building. As a further option, the utilization of Earth's magnetic field (EMF) may be applied.

The material used for constructing the building may affect the EMF measurable indoors and also the EMF surrounding the indoor building. For example, steel, reinforced concrete, and electrical systems may affect the EMF. The EMF may vary significantly between different locations in the building and may therefore enable accurate location discovery and tracking inside the building based on the EMF local deviations inside the building. On the other hand, the equipment placed in a certain location in the building may not affect the EMF significantly compared to the effect caused by the building material, etc. Therefore, even if the layout and amount of equipment and/or furniture, etc., change, the measured EMF may not change significantly.

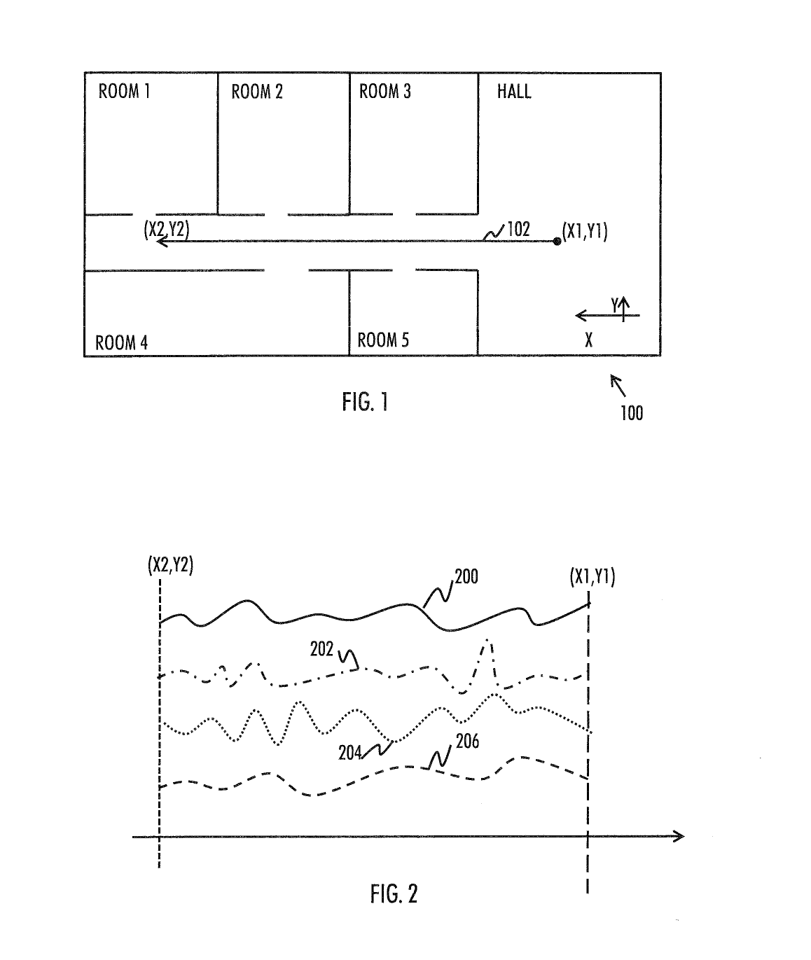

An example of a building 100 with 5 rooms, a corridor and a hall is depicted in FIG. 1. It is to be noted that the embodiments of the invention are also applicable to other type of buildings, including multi-floor buildings. The floor plan of the building 100 may be represented in a certain frame of reference. A frame of reference may refer to a coordinate system or set of axes within which the position, orientation, etc. of a mobile device are measured, for example. Such a frame of reference of the building in the example of FIG. 1 may be an XY coordinate system, also known in this application as the world coordinate system. The coordinate system of the building 100 may also be three dimensional when vertical dimension needs to be taken into account. The vertical dimension is referred with Z, whereas X and Y together define a horizontal two-dimensional point (X,Y). In FIG. 1, the arrow starting at a point (X1, Y1) and ending at a point (X2, Y2) may be seen as a path 102 traversed by a user associated with an EMF mobile device. The vertical Z dimension is omitted for simplicity.

The mobile device is detailed later, but for now it may be said, that the mobile device may comprise a magnetometer or any other sensor capable of measuring the EMF, such as a Hall sensor or a digital compass. The magnetometer may comprise at least one orthogonal measuring axis. However, in an embodiment, the magnetometer may comprise three-dimensional measuring capabilities. Yet in one embodiment, the magnetometer may be a group magnetometer, or a magnetometer array which provides magnetic field observation simultaneously from multiple locations spaced apart. The magnetometer may be an accurate sensor capable to detect any variations in the EMF. In addition to the strength, also known as magnitude, intensity or density, of the magnetic field (flux), the magnetometer may be capable of determining a three-dimensional direction of a measured EMF vector. To this end, it should be noted that at any location, the Earth's magnetic field can be represented by a three-dimensional vector. Let us assume that a compass needle is tied at one end to a string such that the needle may rotate in any direction. The direction the needle points, is the direction of the Earth's magnetic field vector.

As said, the magnetometer carried by a person in the mobile device traversing the path 102 in FIG. 1 is capable of determining the three-dimensional magnetic field vector. Example three components of the EMF vector as well as the total strength are shown in FIG. 2A throughout the path 102 from (X1, Y1) to (X2, Y2). The solid line 200 may represent the total strength of the magnetic field vector and the three other lines 202 to 206 may represent the three component of the three dimensional magnetic field vector. For example, the dot-dashed line 202 may represent the Z component (vertical component), the dotted line 204 may represent the X component, and the dashed line 206 may represent the Y component. From this information, the magnitude and direction of the measured magnetic field vector may be extracted.

In location tracking/discovery of mobile device on the basis of the EMF measurements, or any target object moving in the building 100, each EMF vector measured by the mobile device carried by a person may be compared to existing information, wherein the information may comprise EMF vector strength and direction in several locations within the building 100 or within a plurality of buildings. The information may thus depict an indoor Earth's magnetic field map. As the amount of data in the EMF map, typically covering many buildings, may be large, the EMF map may be stored in a database entity or a server instead of the mobile device having limited computational capabilities. The mobile device may thus transmit EMF measurement results to the database entity in a network, i.e. to a cloud, which performs the comparison against the EMF map. As a result, the database entity may then return a location estimate to the mobile device.

However, in one embodiment, the mobile device may itself apply the stored EMF measurement results for making the location/path estimate. In such case, the database entity as used in the description may locate inside the mobile device. Thus, the mobile device may internally transfer the content of the buffer to the database entity inside the mobile device. The mobile device, or more particularly, the database entity inside the mobile device, may also store the EMF map of the building 100, for example.

Variation of the EMF measurement data, such as of the EMF magnitude or direction may imply that a mobile device (MD) performing the EMF measurements is in motion. However, the EMF information alone does not allow accurate determination of information about the environment in which the mobile device is currently located.

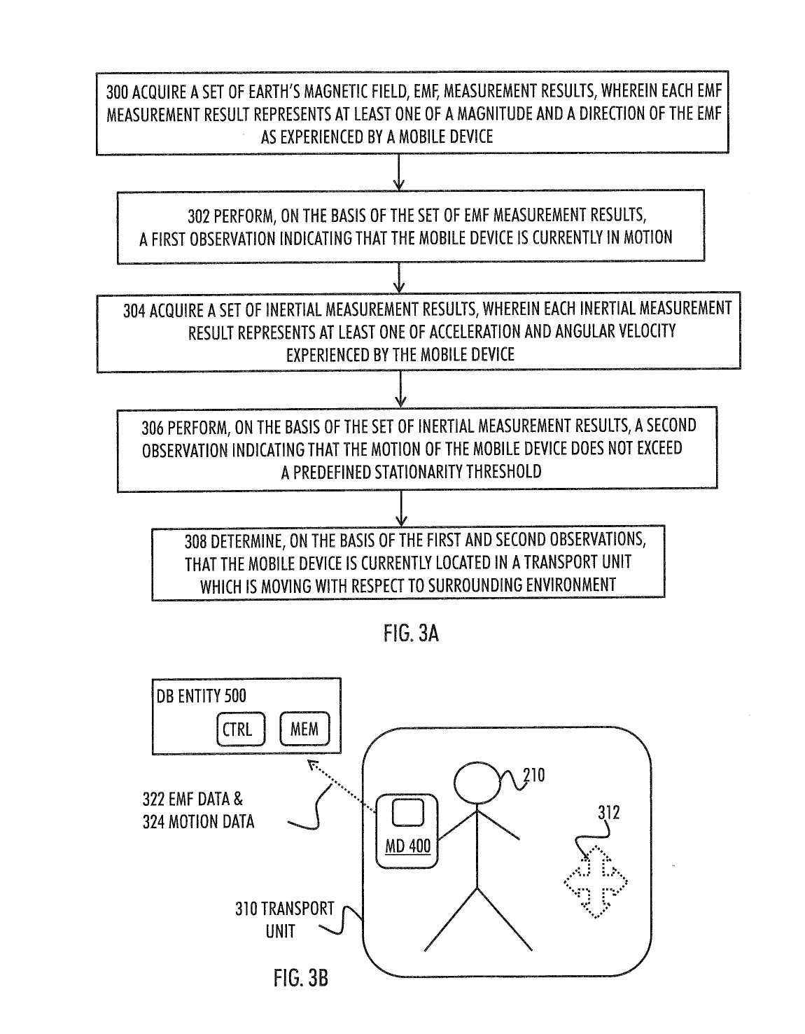

Therefore, as shown in FIGS. 3A and 3B, it is proposed that a database entity 500 acquires, in step 300, a set of EMF measurement results 322, wherein each EMF measurement result represents at least one of a magnitude and a direction of the EMF as experienced by a mobile device (MD) 400. The MD 400 may be carried by a person 210, or it may be attached to another unit, as will be explained later. Although explained here so that the MD 400 transmits wirelessly the data to the database entity 500 in the network, in an embodiment the MD 400 may perform the proposed solution by itself. In such case, the database entity 500 may be seen to be comprised in the MD 400 and an internal transfer of data, for example, from the magnetometer to the internal database entity 500 takes place.

In step 302, the database entity 500 performs, on the basis of the acquired (e.g. wirelessly received or internally transferred via a wire) set of EMF measurement results 322, a first observation indicating that the MD 400 is currently in motion. The set of EMF measurement results 322 may be in time domain, or they may have been converted into frequency domain, if needed. Such observation/determination of motion may be based on detecting variations in the EMF measurement results 322. In an embodiment, if there is no or only a little variation in the EMF measurement results 322, the database entity 500 may decide that the MD 400 is stationary and not in motion.

In step 304, the database entity 500 acquires a set of inertial measurement results 324, wherein each inertial measurement result represents at least one of acceleration and angular velocity experienced by the MD 400. It should be noted that step 304 need not occur after the step 300, but these two steps may take place in any order or even substantially simultaneously. The inertial measurement results 324, i.e. motion data 324, may be measured by at least one inertial measurement unit (IMU) comprised in the mobile device 400. The IMU may comprise at least one acceleration sensor. The acceleration sensor may be capable of detecting the gravitational force G. Owing to the known gravitational force G, the acceleration sensors may be capable of detecting rotations about the X and Y horizontal coordinate axes of a three dimensional (3D) coordinate system of the building. The IMU may optionally also comprise other inertial sensors, such as at least one gyroscope, for detecting angular velocities about the vertical Z axis of the 3D coordinate system, for example.

Next, the database entity 500 may perform in step 306, on the basis of the set of inertial measurement results 324, a second observation indicating that the motion of the MD 400 does not exceed a predefined stationarity threshold. There may be a step in which the database entity 500 detects whether the motion of the MD 400, as indicated by the inertial measurement data 324, exceeds the stationarity threshold or not. The threshold may be empirically derived or mathematically modeled. The in threshold may be defined in spatial domain, for example, thereby indicating an allowed motion of the MD 400 to any given direction in a three- or two-dimensional (3/2D) space. The inertial measurement data 324 may be exposed to a sub-space analysis for extracting different motion components from the acquired motion data 324. The subspace analysis may be also called a dimensionality reduction or projection method. The (stationary) subspace analysis may comprise, for example, independent component analysis (ICA), principal component analysis (PCA), factor analysis, to mention only a few methods known by a skilled person to extract different components from a signal.

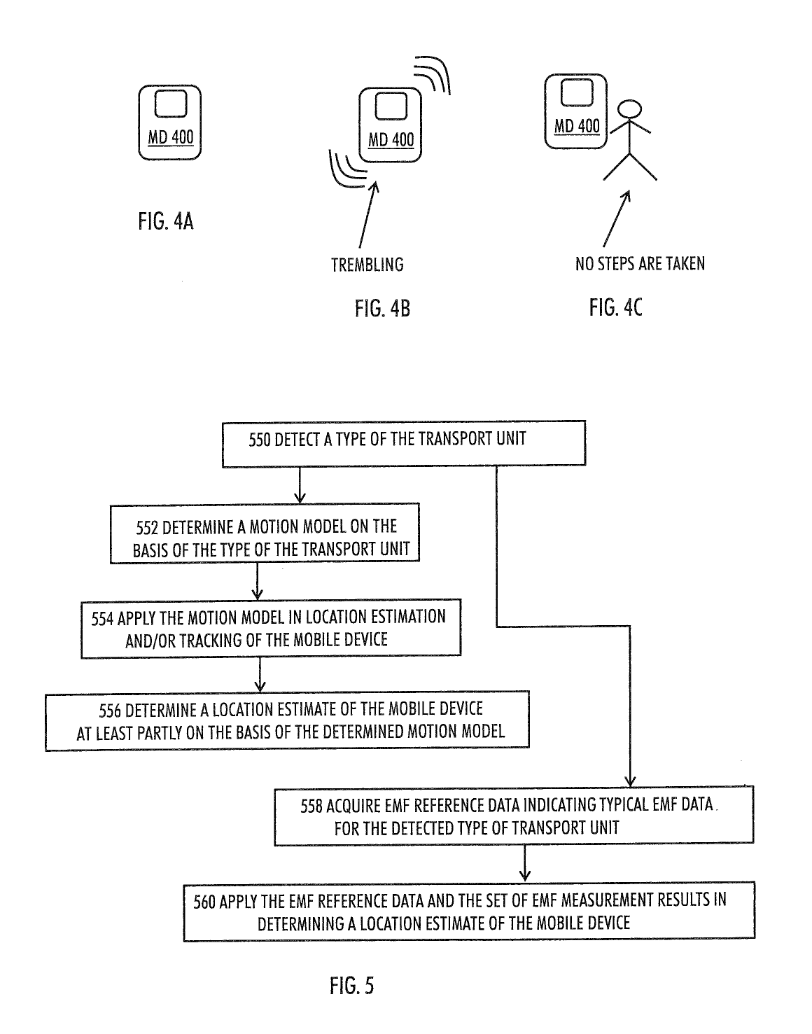

The predefined stationarity threshold may be selected so that a small or regular motion of the MD 400 is below the threshold. Thus, the MD 400 is required to be only substantially stationary. For example, in FIGS. 4A to 4C some embodiments for the use of the stationary threshold are given. In FIG. 4A, the database entity 500 may detect, on the basis of the set of inertial measurement results 324 that the MD 400 is fully stationary (stable). This may be indicated by static (not varying) or noise-like inertial measurement results 324. The noise-like characteristics may be learned and may depend also on the type of the inertial measurement unit(s) applied. This may correspond to a case where the MD 400 is not moved by the person 210 carrying it. The person 210 may be, for example, sitting and have the MD 400 in his/her pocket. The MD 400 may have also been placed on/in some static location, such as on a table. In another embodiment as shown in FIG. 4B, the database entity 500 may detect, on the basis of the set of inertial measurement results 324 that the mobile device experiences vibration or tremble. This may correspond to a case in which the MD 400 is embedded or attached a certain unit which trembles/vibrates, such as a shopping cart while being moved. In yet one embodiment as shown in FIG. 4C, the database entity 500 may detect, on the basis of the set of inertial measurement results 324, that no gait or stride pattern is detected. This may correspond to a case where the MD 400 is hold by a person who is not walking/running (i.e. no steps are taken by a person carrying the MD 400), or that the MD 400 is not carried by a person but placed somewhere. In an embodiment, the database entity 500 may detect, on the basis of the set of inertial measurement results 324, that the MD 400 is not exposed to a linear (onward) motion in a horizontal direction (such as walking).

Thereafter, on the basis of the first and second observations, the database entity 500 may determine in step 308 that the MD 400 is currently located in a transport unit 310 which is moving with respect to surrounding environment. In other words, the determination of step 308 may be due to the detection that the EMF measurement results 322 are varying but the inertial measurement data 324 is not, at least not much. Thus, the varying EMF data 322 may not be caused by a person 210 moving through a non-constant magnetic field, but there may be some transport unit 310 which moves and carries the MD 400 through a non-constant magnetic field and, thus, causes the EMF measurement results 322 to vary. The movement of the transport unit 310 is shown with a multidirectional arrow 312 in FIG. 3B.

Moreover, the database entity 500 may determine that the MD 400 is substantially stationary with respect to the transport unit 310. This is because the acquired inertial data 324 may indicate that the MD 400 is not moving, at least not much. Thus, most or all of the variation of the EMF data 322 is due to the movement of the transport unit 310 through a non-constant magnetic field. By substantially stationary it is meant that the MD 400 may be exposed to small movements with respect to the transport unit 310. For example, while the person 210 is in an elevator, which may be seen as one possible transport unit 310, the person 210 may move or/and rotate the MD 400 in his/her hands while otherwise staying still in the elevator. It may be noted that rotating the MD 400, for example, such that the MD 400 is not exposed to linear motion (e.g. around the center of gravity of the MD 400) may not cause any effect to the measured EMF strength.

In an embodiment, the amount of rotation of the MD 400 about the horizontal axes (X, Y) of the 3D coordinate system of the person 210 (e.g. tilt) may be determined on the basis of the acquired inertial data 324 and the known direction of gravity G caused by the Earth's gravitation. Thereafter, the database entity 500 may align the 3D orientation of the MD 400 with a 2D plane defined by the horizontal axes (X, Y) of the 3D coordinate system of the person 210. Further, the acquired EMF measurement result data may be adjusted on the basis of the determined amount of rotations about the horizontal axes. Thus, the acquired data may now advantageously be presented in 2D (i.e. in the floor plane).

Further, it may be advantageous to determine the magnitude of the XY-plane projection and the magnitude of the Z-component. Namely, the norm of the XY-plane projection ∥m∥xy of the EMF vector m=(X,Y,Z) may be determined as ∥m∥xy=sqrt(X²+Y²). As a result, the feature vector (Z, ∥m∥xy) may be computed from the tilt compensated magnetic field observation, which feature vector is invariant to the rotation about the Z-axis. These two features may enable for more EMF vector information than the total magnitude alone, because the magnitude may be represented separately for the Z-axis component and for the XY-plane projection.

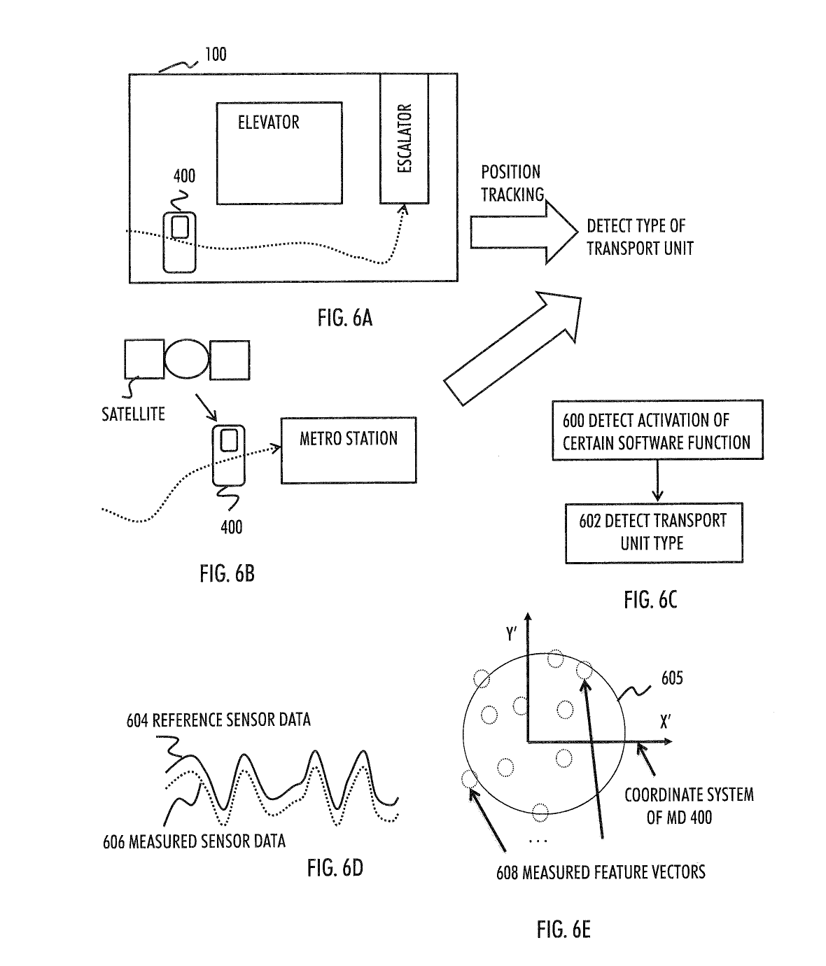

Let us next take a look at some embodiments related to selection of a motion model for location estimation/tracking of the MD 400. It should be noted that some location estimation/tracking techniques, such as the one based on EMF measurements, may benefit from a reliable and accurate motion model depicting the movement of the MD 400 because then the amount of location hypotheses of the MD 400 may be reduced and locating the MD 400 becomes more efficient. As shown in FIG. 5, the motion model may, in step 552, be determined on the basis of a detected type of the transport unit 310, wherein the detection of the transport unit 310 takes place in step 550. The type of the transport unit 310 may indicate which kind the transport unit 310 is, such as an elevator, an escalator, a human conveyer belt, an indoor vehicle, an underground subway, or any transport unit which is typically applied in environments where EMF based location estimation/tracking is useful, and where a transport unit travels or moves through a non-constant magnetic field. Further, the detection of the type of the transport unit 310 may identity the transport unit 310, such as which elevator or escalator within the building it is. Let us next look at how the transport type may be detected according to various different embodiments as depicted in FIGS. 6A to 6E.

In some embodiments, as shown in FIGS. 6A and 6B, the database entity 500 may determine movement history of the MD 400 on the basis of location estimation and/or tracking of the MD 400 and detect the type of the transport unit 310 on the basis of the movement history. The movement history may be acquired by applying any given location estimation/tracking technique known to a skilled person. For example, in FIG. 6A, the MD 400 is moving inside the building 100. In such case, the location tracking based on EMF measurements, radio frequencies (GSM, LTE, WiFi, WLAN), machine vision, etc. may be applied. Further, any proximity based location estimation and/or tracking may be applied. However, in case of FIG. 6B, the MD 400 is moving outside. In such case, the location tracking may be instead or additionally performed with a satellite based navigation, such as by applying the GPS.

In both cases, a map corresponding to the used location estimation technique may be applied so that the transport unit 310 may be detected. For example, in FIG. 6A, the map may be an EMF map representing at least one of magnitude and direction of EMF affected by the local structures at a given location of the indoor environment, such as the building 100. The EMF map may be projected on a map indicating the locations of elevators, escalators, or in general, transport units inside the building. For example, in FIG. 6A, the movement history may indicate that the MD 400 entered or at least approached a location in which the escalator is located. The elevator, possibly locating next to the escalator, was not entered. Thus, in this case it may be detected that the escalator is the transport unit 310.

In case of FIG. 66, it may be observed, based on the outdoor movement history, that the MD 400 approaches and/or enters an underground subway (metro) station. Therefrom it may be derived that the MD 400 may soon enter a subway train. Naturally, there may be indoor location tracking applied in the metro station to more accurately determine when and which train has been entered, etc. However, this is not necessary. Thus, in this case, the subway train may be detected to be the transport unit 310.

In FIG. 6C, it may be detected that a certain at least one software function is activated in the MD 400 in step 600. As a result, the type of the transport unit 310 may be detected on the basis of what at least one software function is activated in step 602. Such detection may be based on empirical data representing typical human behavior in some transport units. For example, it may be that typically a person in an elevator checks whether or not any calls, messages, emails, and/or social media messages have been received. Thus, a detection of such software function in the MD 400 may imply that the MD 400 is currently in an elevator. As another example it may be said that detecting an activation of a software function displaying a metro station map in the MD 400 may imply that the person carrying the MD 400 is currently in a subway. Further, it may be that the MD 400 automatically triggers a known software function when it is detected, on the basis of proximity techniques, for example, that the MD 400 enters a specific transport unit, such as an elevator. Such automatically triggered function may be, for example, metro map, a Facebook or a Four Square application posting a status message in the social media. These are simply non-limiting examples of the embodiments of FIG. 6C.

In the example of FIG. 6D, it may be that the database entity 500 acquires reference sensor data 604 corresponding to a plurality of transport types. The reference sensor data 604 may relate to reference EMF data, reference inertial data, reference microphone data, reference altitude data, reference pressure data, or to any reference data which may be used to detect the transport unit type. The reference sensor data 604 may have been measured by a measuring device locating in a given transport unit and stored by the database entity 500. The measuring device may comprise the corresponding type of sensor for measuring the reference sensor data 604. The reference sensor data 604 may have been recorded previously for a plurality of transport unit types. There may be one sensor data record 604 corresponding to all transport units 310 of a specific type, such as elevators. Thus, the sensor data 604 of this type may be average sensor data 604 for a specific sensor type, such as for an elevator. However, in one embodiment, there is specific reference sensor data 604 for each transport unit 310, such as for each elevator, for each subway, etc. This may help identifying the transport unit 310, in addition to detecting the type of the transport unit 310.

Thereafter, the database entity 500 may compare the reference sensor data 604 to a data 606 sensed by at least one sensor of the MD 400, wherein the reference sensor data 604 is related to the corresponding at least one sensor. Thus, if the MD 400 uses a microphone to sense the environment, then this measured microphone data 606 is compared against a reference microphone data 604. The comparison may include comparing time series of the data 604, 606, comparing the data 604, 606 in frequency domain, comparing certain statistical features/characteristics derived/extracted from the data 604, 606, for example. As a result, the database entity 500 may detect, at least, the type of the transport unit 310 on the basis of the comparison. In a further embodiment, also an identification of the transport unit 310 is performed on the basis of the comparison.

It should be noted that, for example, the reference sensor data 604 relating to EMF measurements in an elevator may show variations due to change in the building constructions. For example, passing through the steel structures between different floors of the building may cause specific signal patterns in the measured EMF data. The detected signal patterns may be periodic due to at least somewhat constant speed of the elevator, and/or repeating steel structures. Thus, the reference sensor data 604 may comprise a periodic signal pattern specific for a specific type of transport unit. Consequently, this type of reference EMF sensor data 604 may be significantly different than if the person were walking along a corridor, for example. Therefore, it may be used as a characterizing reference sensor data 604 for an elevator. Similarly, suitable characterizing reference sensor data may be obtained for a variety of transport units 310. The suitable type of sensor to be used in a given transport unit 310 may be empirically selected. As said, for an elevator, the EMF sensor data may be suitable. Also pressure or altitude sensor data may work for an elevator, for example. For a subway, reference microphone data or reference EMF data may provide characterizing reference data for distinguishing between different transport unit types, to mention only a few non-liming examples.

In an embodiment, the MD 400 is on a shopping cart. In such case, the MD 400 may be exposed to vibration or trembling movement. Thus, reference sensor data 604 characterizing the shopping cart as the transport unit 310 may include, for example, inertial motion sensor data. For example, as shown in FIG. 6E, there may be certain features extracted from the reference inertial data and a distribution 605 of those features may be used as the reference sensor data, as marked with a solid large circle in FIG. 6E. Thereafter, corresponding features may be extracted from the acquired, measured inertial data 324. These extracted features 608 are marked with a plurality of small circles. As the extracted features match relatively well with the distribution 605 as the reference sensor data 604, the database entity 500 may decide that the MD 400 is currently in the shopping cart. It may be noted that, in case the extracted features 608 are related to the dominant motion direction of the MD 400, then in the shopping cart (in which the MD 400 may tremble in all directions) the distribution 605 may show that there is/are no specific moving direction(s) which dominate(s), but all the directions are somewhat equal due to the omnidirectional trembling of the MD 400. Therefore, such distribution 605 may be seen as a characterizing reference sensor data 604 for the shopping cart.

In an embodiment, the at least one feature 608 is extracted continuously or repeatedly from the motion data 324. Each instantaneous feature may be plotted/projected in a 3- or a 2-dimensional coordinate system as feature vectors. Thus, the extracted features may be multidimensional. This is shown in Figure GE with respect to projection to 2D coordinate system (X′, Y′) of the MD 400. The at least one feature (vector) 608 may be acquired from the raw motion data 324 or they may be derived from the motion data 324. In an embodiment, the feature extracted from the motion data 324 may be a derived parameter or abstraction of the acquired motion data 324. The extracted features may represent, e.g., time and/or frequency components computed from the motion data 324. In an embodiment, the feature(s) may represent a moving variance between consecutive motion data values. In an embodiment, the feature(s) may represent dominant frequency component(s) and/or phase component(s) of the motion data 324. In order to acquire the frequency components, there may be a spectrum analysis or a 2D/3D Fourier transform performed for the motion data 324. In an embodiment, the feature extracted from the motion data 324 may be a time series of raw motion data 324 with respect to at least one motion component (e.g. as depicted in FIG. 6D). In an embodiment, the extracted features represent the dominant motion direction of the MD 400 in a three- or two-dimensional coordinate system of the MD 400.

In an embodiment, the speed of the shopping cart as the transport unit 310 may affect the trembling experienced by the MD 400 mounted on the shopping cart. Further, different reference sensor data 604 may be learned for the shopping cart, wherein different reference sensor data 604 may correspond to different speeds of the shopping cart, for example. Therefore, the database entity 500 may, in an embodiment, also determine an indication of the speed of the shopping cart based on the statistical analysis of the observed vibration experienced by the mobile device 400 mounted on the shopping cart. The determination may also comprise comparing a set of reference data (including a plurality of reference data corresponding to a plurality of speeds) to the measured motion data 324, and detecting which reference data matches with the measured inertial data 324. Thereafter, the speed of the shopping cart may be estimated to correspond to the speed which is associated with the reference data which provides the best match with the measured motion data 324. More specifically, the movement detection and speed estimation of the shopping cart may be based on statistical classification (e.g., k-nearest neighbor, logistic regression, or kernel classifiers) or regression (e.g., linear regression or kernel regression) models trained in order to obtain reference speed data. Thereafter, at least one feature in time (e.g., short-time statistics) or frequency (e.g., short-time Fourier coefficients) domain may be extracted from the inertial motion data 324, wherein the at least one feature reflects the vibration experienced by the MD 400. Then, the comparison of the extracted at least one feature against the same feature of the plurality of reference (speed) data may be performed in order to detect which reference (speed) data matches the best with the acquired motion data 324. However, in an embodiment the speed estimation may be performed without the reference data, on the basis of the measured motion data 324, with a reasonable accuracy. For example, the frequency and amount of vibration may be determined from the motion data 324 and this may indicate what the speed of the MD 400 mounted on the shopping cart is.

Similarly, one elevator may travel faster than another. This may be determined on the basis of the frequency of variation in the measured EMF data or on the basis of altitude/pressure sensor data, for example. Such determination of the speed of the transport unit 310 may be advantageous as the speed may affect the motion model determination. As such, there may be different motion models stored for each transport unit type, and the selection of which one of them to use may depend at least partly on the detected speed of the transport unit 310.

Now let us get back to FIG. 5 which states in step 552 that a motion model of/for the MD 400 is selected on the basis of the detected transport unit type. It may be noted here that, for example, location estimation/tracking based on EMF data may lack in accuracy in case no motion model is acquired. As the inertial motion data 324 does not provide such motion model (e.g. no steps are detected), the motion model may need to be obtained in another manner in order to increase the accuracy. Accordingly, the motion model may be advantageously obtained as shown in the method of FIG. 5.

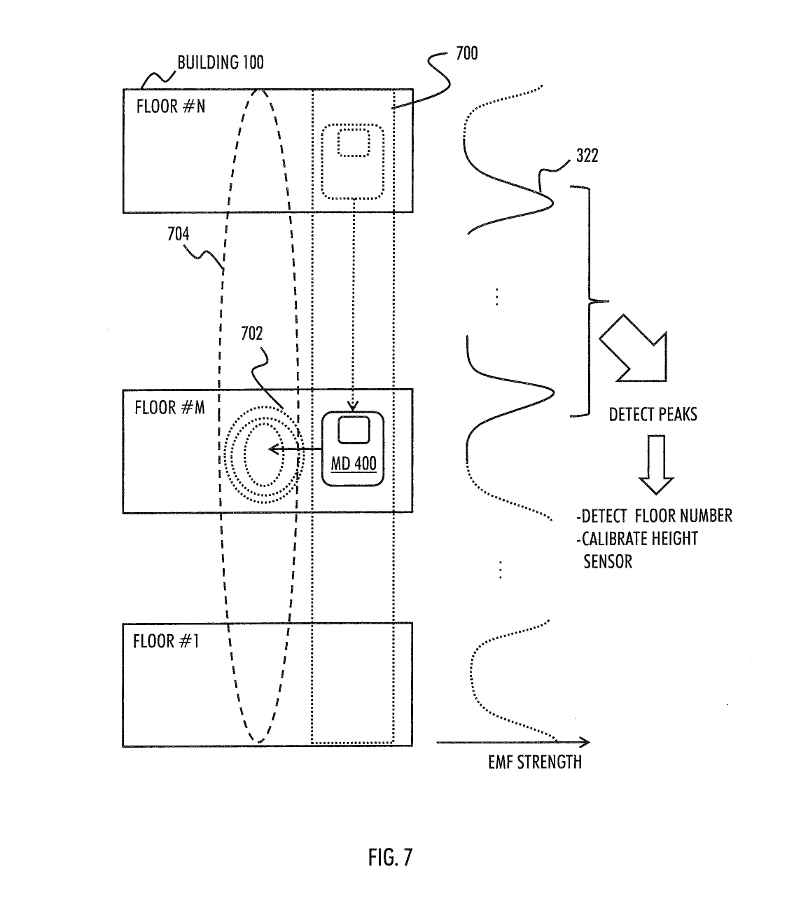

In step 554, the motion model is applied in location estimation and/or tracking of the mobile device 400. The motion model may indicate at least one of the following: speed of motion, direction of motion, duration of motion, distance travelled, floor number. For example, if it is detected that the transport unit 310 is an escalator, then it may be determined that the speed of the MD 400 on the escalator corresponds to predefined, typical value. Further, it may be determined that, in an escalator, the MD 400 will travel one floor up or down. The direction of the motion (up/down, in a case of the escalator) indicated by the motion model may be obtained from the pressure sensor data or from the location tracking map comprising information about the infrastructure of the building, for example. The distance travelled may be also determined and included into the motion model on the basis of the detected type of transport unit 310. For example, the length of an escalator may be known. The floor number detection in case of the escalator is +/−1 floor from the current floor, whereas the change in the floor number in case of an elevator may be more than one. Let us take a look at this elevator embodiment later with reference to FIG. 7. In any case, the motion model, which is selected on the basis of the detected/identified transport unit 310, and possibly further on the basis of the estimated speed of the transport unit 310, may be used for the location estimation.

In an embodiment, there may be many possible transport units detected. In such case, these transport units may be seen as candidate transport unit or transport unit hypotheses. These hypotheses may each be tested by analyzing the acquired EMF and inertial data 322, 324. By performing such analysis it may be noted that one of the hypothesis is more probable than the others and the location estimation/tracking may apply the motion model corresponding to that transport unit hypothesis in location tracking.

Moreover, the detection of being static in a moving transport unit may in an embodiment be used to emphasize areas of possible transport units in the location estimation and/or tracking. For example, owing to such detection, the location estimation tracking technique may assume that the person 210 carrying the MD 400 entered one of the elevators of the building or is in one of the escalators, for example.

In an embodiment, the database entity 500 may store different motion models for different transport units 310, and possibly for different estimated speeds of each transport unit 310, in the memory of the database server 500. Then, on the basis of the detection of the type of the transport model 310, the database entity may select the corresponding one from the set of motion models. The stored motion models may correspond to typical motion of the corresponding transport unit 310. In an embodiment, however, the database entity 500 generates the motion model on the basis of the information obtained from different sensors of the MD 400. For example, if the speed of the transport unit 310 is possible to be estimated, then at least this estimated speed may be used for generating the motion model.

In an embodiment, in step 556, a location estimate of the mobile device 400 may be determined at least partly on the basis of the determined motion model, wherein the location estimate corresponds to the location in which the mobile device 400 currently is and is used for location estimation and/or tracking of the mobile device 400. For example, knowing the speed of the MD 400 on the basis of the motion model may help in estimating the current location of the MD 400. As the person exits the transport unit 310, it may be beneficial to be able to continue the location estimation quickly and accurately. The determined location estimate may provide an efficient way of doing so.

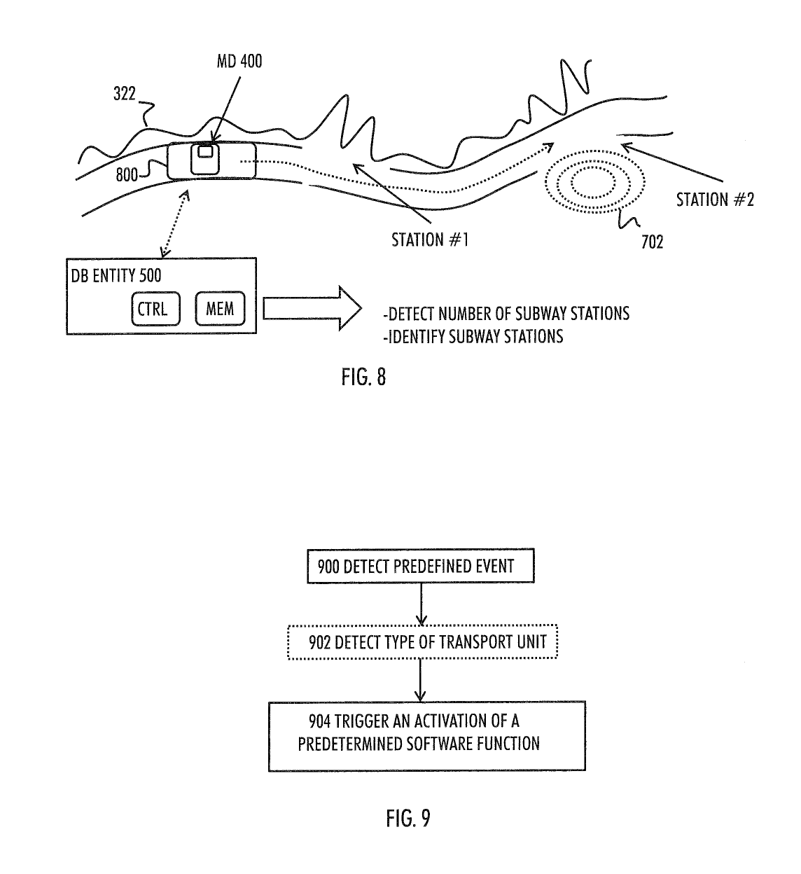

In one embodiment, the database entity 500 may, in step 558, acquire EMF reference data (such as marked with reference numeral 604 shown in FIG. 6D) indicating typical EMF data for the detected type of transport unit 310, such as for the elevator (as discussed later with reference to FIG. 7) or for the subway (discussed with reference to FIG. 8 later). The reference EMF data may indicate what the behavior of the EMF data 322 corresponding to certain transport unit 310 is. The database entity 500 may for example store such reference EMF data in its memory for a plurality of transport units. Thereafter, in step 560, the EMF reference data and the set of EMF measurement results 322 may be applied in determining a location estimate of the MD 400.

With reference to FIG. 7, let us imagine, for example, that the MD 400 enters an elevator 700 as the transport unit 310 in a floor #N. Thereafter, the MD 400 starts travelling downwards, as shown with a dotted arrow, and exits the elevator 700 in a floor #M. The measured EMF data 322 is shown in FIG. 7 with respect to the height. As indicated earlier the EMF data 322 measured in an elevator may comprise periodic specific patterns representing a change of a floor. The solid part of the EMF data 322 is measured and a dotted part indicates how the measured EMF data 322 may behave throughout the whole length of the elevator 700. Now, let us assume that it is detected that the MD 400 is currently in the elevator 700 on the basis of any of the embodiments as described in FIGS. 6A to 6E. Let us further assume that, on the basis of location estimation/tracking, it is known that the MD 400 entered the elevator 700 in the floor #N.

In an embodiment, the determined motion model may be used in estimating the current location (e.g. current floor) of the MD 400. This is because the motion model may indicate the movement speed of the elevator 700, the direction of movement, etc. Further, it may be predefined knowledge that typically a height of a floor is 2.4 meters, for example. It may be noted that the direction of motion may be acquired from the EMF measurement data 322, for example if the metal structures of the building are non-symmetrical or not fully periodic. There may also be a reference EMF data used for detecting the direction of the motion, speed of motion, etc. Also pressure or altitude sensor data may work for the elevator in indicating the speed or direction of motion, for example

However, in addition to or instead of the motion model, the database entity 500 may estimate, on the basis of the set of EMF measurement results 322, the number of floors the mobile device 400 travels in the elevator 700 before exiting the elevator. This may be performed by detecting how many peaks, or periodic patterns in general, representing a change of a floor, are encountered in the received EMF data 322. For example, three peaks may indicate that the MD 400 passed three floor ceilings. Thus, in this case there would be three floors between the floors #N and #M.

As a result, the database entity 500 may determine a location estimate 702 of the mobile device 400 on the basis of the estimation of how many floors the mobile device 400 travelled in the elevator 700. The location estimate may, in an embodiment, correspond to the exit location in front of the elevator 700 in the floor #M, which may correspond to a floor #N−3. This may be beneficial as then the location estimate, or location hypotheses after exiting the elevator 700 need not cover all the elevator exits in all the floors, as shown with a dashed large ellipse 704, but may correspond to the significantly smaller, correct location in the floor #M. This may significantly speed up the location estimation/tracking after exiting the elevator 700 as there is no need to test location hypotheses in several floors. It should be noted that the location estimate 702 may be further verified or adjusted on the basis of other location tracking techniques applying for example WiFi radio signals, pressure sensors, proximity detection.

It should be noted that the floor number (i.e. height) of the MD 400 may be determined continuously in the elevator 700, i.e., not only when the MD 400 exits the elevator 700. Thus, in an embodiment, the current floor number of the mobile device 400 may be determined on the basis of the estimation representing the number of floors the mobile device 400 travelled in the elevator 700. In an embodiment, an elevation sensor comprised in the mobile device 400 may be calibrated on the basis of the knowledge of the current floor number, distance travelled, or estimated speed. For example, the database entity 500 may indicate the current floor number to the MD 400 so that the MD 400 may perform the calibration of the elevation/altitude sensors, such as a pressure sensor. In yet one embodiment, the pressure sensor may be calibrated by detecting how many pressure units certain change in a floor number represents.

Let us then take a look at another embodiment with respect to FIG. 8 in which the MD 400 is located in a subway 800 as the transport unit 310. In this case, the database entity 500 may detect, on the basis any of the embodiments provided in FIGS. 6A to 6E (such as by applying GPS or any indoor location estimation/tracking technique), that the MD 400 is currently in an underground subway 800, wherein the underground subway 800 is the transport unit 310. In FIG. 8 the measured EMF data 322 is also shown along the movement of the MD 400 in the subway 800. As shown, the EMF data 322 may show distinctively different behavior when the subway 322 is at or passes an underground station #1 and/or #2. This may be, for example, because at the locations of the stations #1 and #2, the subway tunnel is open at least on one side, whereas it is otherwise a closed tunnel surrounding the subway 800. There may be, for example, an anomaly exceeding a predefined anomaly threshold detectable from the EMF data 322 at the locations of the stations #1 and #2. As another example, there may be certain feature(s) derived from the received raw EMF data 322. The feature(s) to be derived may be selected, for example based on empirical experimentation, so that they indicate a presence of an underground station.

It may also be that there is a reference EMF data recorded for each tunnel and station, or for the whole subway line and the reference EMF data is compared against the measured EMF data 322 to more reliably indicate a presence or passing of a certain subway station. In such embodiment, it may be possible to identify the at least one subway station #1 and/or #2 on the basis of the set of EMF measurement results 322 and reference EMF data representing EMF data for the at least one subway station #1, #2. Similar reference data (EMF data, inertial motion data, microphone data, etc.) may be stored for any transport unit 310 for allowing identification of the transport unit 310.

Further, it may be noted that the subway line may comprise parts on the surface of the ground. These surface-parts may also provide characteristic EMF features/patterns.

Thus, it may be possible that the database entity 500 estimates, on the basis of the set of EMF measurement results 322, the number of at least one subway station #1 and #2 that the MD 400 passes in the underground subway 800 before exiting the underground subway 800. As a result, similar to the elevator embodiment of FIG. 7, a location estimate 702 of the mobile device 400 may be determined on the basis of the estimation of the number of subway station(s) the MD 400 passes. In case the MD 400 exits the subway 800 in the station #2, the location estimate may correspond to a specific exiting location inside the metro station #2 for indoor location estimation/tracking or it may correspond to a specific outdoor location in front of the metro station #2 for outdoor location tracking. Also here it is to be noted that such location estimate may be derived constantly while the MD 400 is in the subway 800 based on the EMF data 322 and/or motion model corresponding to the subway 800. The motion model may in this case comprise information of an expected speed of the subway 800. In case there exists EMF map for the subway line, normal EMF based location estimation and/or tracking may be performed.

In an embodiment, as shown in FIG. 9, the database entity 500 may, in step 904, trigger an activation of a predefined software function in or with respect to the MD 400 upon detecting a predetermined event. The predetermined event detected in step 900 may be one or more of a plurality of options.

In an embodiment, the predetermined event detected in step 900 may comprise detecting that the transport unit starts moving. This may be detected by analyzing the EMF data 322 and detecting that it starts varying although the inertial data 324 indicates that the MD 400 is substantially stable.

In an embodiment, the predetermined event detected in step 900 may comprise detecting that the transport unit stops moving. Again this may be detected, for example, from the EMF data 322 stabilizing.

In an embodiment, the predetermined event detected in step 900 may comprise detecting that the mobile device enters or is about to enter the transport unit. This may be detected on the basis of the location estimation/tracking of the MD 400 prior to entering the transport unit 310, or on the basis of proximity detection technology (e.g. RFID) if the transport unit 310 is equipped with such, for example.

In an embodiment, the predetermined event detected in step 900 may comprise detecting that the mobile device exits the transport unit. Similarly, this may be detected by the inertial data starting to show variations indicating movement of the person carrying the MD 400, for example.

In an embodiment, the predetermined event detected in step 900 may comprise detecting that the mobile device is currently located in the transport unit 310. This may be detected on the basis of the detection in step 308.

In an embodiment, the predetermined event detected in step 900 may comprise detecting, on the basis of the determined location estimate 702, that the mobile device is currently located in a certain predetermined location.

The predetermined software function may be any given function installed in the MD 400 or provided to the MD 400 from a cloud in the network, such as from the database entity 500. To mention a few examples, the software function to be triggered on may be map of the metro stations, log in to social network (such as Four Square, Facebook, Twitter), posting an update to such social network service, fetching and displaying a map of the floor to which the MD 400 enters, notifying a passenger carrying the MD 400 when the train arrives to a station, etc. In one embodiment, the software function may relate to purchasing a ticket for the journey in the subway. For example, a ticket purchasing software application may be automatically triggered on upon detecting that the MD is in the subway 800. Thereafter, the ticket purchasing software application may keep track of the stations passed. When the passenger leaves the subway 800, the ticket purchasing software application automatically computes the price for the journey on the basis of the amount of stations passed and possible further on the basis of the identification of the stations. In case the passenger forces a shutdown of the ticket purchasing software application, the ticket purchasing software application may automatically deduct a predetermined amount from the passenger's account (bank account or possibly an account corresponding to the subscriber identity module card (SIM-card) of the MD 400).

In an embodiment, the software function may comprise a change of access rights of the person associated with the MD 400. This type of function may be triggered, for example, when the MD 400 provides for access in the building and it is detected that the MD 400 is entering to a restricted area of the building. A further possible software function may include display of an advertisement in the MD 400 when it is detected that the MD 400 is or exits the transport unit 310 in a floor in which the items corresponding to the advertisement are sold.

In an embodiment, the detected type of the transport unit 310 is used in step 902 to define which software function is to be triggered. For example, the metro map may be triggered while being in a subway 800, the map of a floor of a shopping centrum may be provided to the MD 400 while the MD 400 is in an elevator/lift, or escalator, for example. A map of the airport may be provided to the MD 400 when the MD 400 is detected to be in the conveyer belt or an indoor vehicle in the airport, a social network status update may be automatically posted when it is detected that the subway stops at some specific station or when the elevator stops at some specific floor, to mention only a few possible options of the triggered software function.

In an embodiment, the database entity 500 may identify the transport unit 310 associated with each of a plurality of mobile devices and determine the number of mobile devices in a certain, identified transport unit. Let us consider, for example, that the transport unit 310 is a specific subway train 800 moving between stations #1 and #2. As a result, the database entity 500 may perform an analysis about how crowded the transport unit 310 (i.e. the subway 800 in this example) is on the basis of the determination. Such crowd analysis may be provided to MDs which are later detected to be approaching the specific subway 800. Advantageously, it may be that the persons carrying those later detected MDS may decide to pursue another subway, in case the crowd analysis indicates that the subway 800 is full. A further use case for the crowd analysis is to apply them when performing predictions of crowded areas/event, such as upcoming football matches. In other words, if it is detected that a subway is crowded and travelling towards certain station close to an upcoming football match, then it may be predicted that the football match will be crowded and additional security staff may be arranged, for example.

Further, in an embodiment, the detection of congested areas may be performed with a granularity of a subway car. The car in which a specific MD 400 is may be detected on the basis of EMF measurement results 322 and reference data. For example, phase differences in the obtained EMF data from two or more different mobile devices may imply where they are mutually located in the subway (note that the speed of the subway may be known: it may be constant or on the basis of reference EMF data). Such knowledge of persons' mutual whereabouts in the same subway may provide a possibility for informing other people about the seat/car in which the person currently is in the subway. Further, social network applications, such as Waze, may be used.

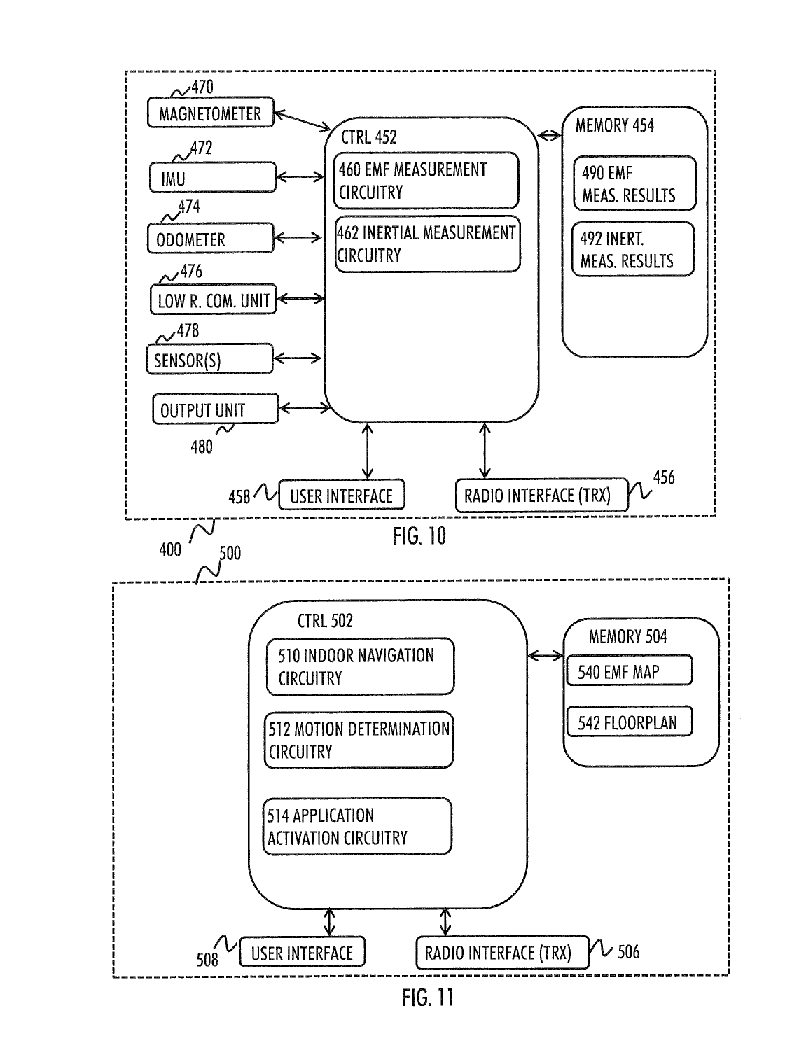

Embodiments, as shown in FIGS. 10 and 11, provide apparatuses 400 and 500 comprising at least one processor 452, 502 and at least one memory 454, 504 including a computer program code, which are configured to cause the apparatuses to carry out functionalities according to the embodiments. The at least one processor 452, 502 may each be implemented with a separate digital signal processor provided with suitable software embedded on a computer readable medium, or with a separate logic circuit, such as an application specific integrated circuit (ASIC).

The apparatuses 400 and 500 may further comprise radio interface components 456 and 506 providing the apparatus 400, 500, respectively, with radio communication capabilities with the radio access network. The radio interfaces 456 and 506 may be used to perform communication capabilities between the apparatuses 400 and 500. The radio interfaces 456 and 506 may be used to communicate data related to the measured EMF vectors 322, to location estimation, to inertial data 324 etc.

User interfaces 458 and 508 may be used in operating the measuring device 400 and the database entity 500 by a user. The user interfaces 458, 508 may each comprise buttons, a keyboard, means for receiving voice commands, such as microphone, touch buttons, slide buttons, etc.

The apparatus 400 may comprise the terminal device of a cellular communication system, e.g. a computer (PC), a laptop, a tabloid computer, a cellular phone, a communicator, a smart phone, a palm computer, or any other communication apparatus. In another embodiment, the apparatus is comprised in such a terminal device, e.g. the apparatus may comprise a circuitry, e.g. a chip, a processor, a micro controller, or a combination of such circuitries in the terminal device and cause the terminal device to carry out the above-described functionalities. Further, the apparatus 400 may be or comprise a module (to be attached to the terminal device) providing connectivity, such as a plug-in unit, an “USB dongle”, or any other kind of unit. The unit may be installed either inside the terminal device or attached to the terminal device with a connector or even wirelessly. In another embodiment, the apparatus 400 is the mobile device 400. The apparatus 500, as the database entity may locate in the network or in the MD 400. The apparatus 500 may be a server computer locating in the network.

As said, the apparatus 400, such as the mobile phone, may comprise the at least one processor 452. The at least one processor 452 may comprise an EMF measurement circuitry 460 for performing EMF measurements with the help of a magnetometer 470. An inertial measurement circuitry 462 may be for processing and performing inertial measurements with the help of an IMU 472 or an odometer 474, for example.

The magnetometer 470 may be used to measure the EMF vector. There may be various other sensors or functional entities comprised in the MD 400. These may include an inertial measurement unit (IMU) 472, the odometer 474, a low range communication unit 476 for detecting the presence of a proximity communication signal, additional sensors, such as at least one camera, sensors 478, such as a pressure sensor, an altitude sensor, for example. A skilled person understood that these may be of use when performing the embodiments as described earlier. For example, the IMU 472 may comprise for example acceleration sensor(s) and at least one gyroscope, for example. The apparatus 400 may further comprise output unit 480 comprising, e.g. a display or a speaker, for outputting information such as advertisements to the person.

The memory 454 may comprise space 490 for storing the set of EMF measurement results 322 and space 492 for storing the inertial measurement results 324.

As earlier said, in an embodiment, the apparatus 400 comprises the apparatus 500. However, in another embodiment, the apparatus 500 is located in the network.

The apparatus 500, such as the database entity, may comprise the at least one processor 502. The at least one processor 502 may comprise several circuitries. As an example, an indoor navigation circuitry 510 for performing indoor navigation on the basis of the received set of Earth's magnetic field measurement results and EMF map. For the navigation, the memory 504 may comprise the EMF map 540, and the floor plan 542 of the corresponding environment, such as of the building 100. The database entity 500 may indicate the position of the MD 400 within the building 100. The circuitry 510 may apply for example multi-hypothesis location estimator/tracker/filter, for example. A motion determination circuitry 512 may be for determining information related to the motion of the MD 400, such that the MD is staying relatively still with respect to the transport unit 310, wherein the transport unit 310 is moving. An application activation circuitry 514 may be responsible of causing an activation of a software function in or with respect to the MD 400.

As may be understood by a skilled person from the description of the embodiments throughout the application, the embodiments may be performed in the MD 400, in the database entity 500, or the execution of embodiments may be shared among the MD 400 and the database entity 500. The skilled person also understands that any required filtering logic may be applied to filter the EMF measurements in order to improve the accuracy.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a entity, a cellular network device, or another network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. Coding of software for carrying out the embodiments as shown and described is well within the scope of a person of ordinary skill in the art.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An apparatus, comprising:
at least one processor and at least one memory including a computer program code, wherein the at least one memory and the computer program code are configured, with the at least one processor, to cause the apparatus at least to:
acquire a set of Earth's magnetic field, EMF, measurement results, wherein each EMF measurement result represents at least one of a magnitude and a direction of the EMF as experienced by a mobile device;
perform, on the basis of the set of EMF measurement results, a first observation indicating that the mobile device is currently in motion;
acquire a set of inertial measurement results, wherein each inertial measurement result represents at least one of acceleration and angular velocity experienced by the mobile device;
perform, on the basis of the set of inertial measurement results, a second observation indicating that the motion of the mobile device does not exceed a predefined stationarity threshold; and
determine, on the basis of the first and second observations, that the mobile device is currently located in a transport unit which is moving with respect to surrounding environment.

2. The apparatus of claim 1, wherein the at least one memory and the computer program code are configured, with the at least one processor, to cause the apparatus further to:
detect, on the basis of the set of inertial measurement results, at least one of the following: the mobile device is stable, the mobile device experiences vibration or tremble, no gait pattern is detected.

3. The apparatus of claim 1, wherein the at least one memory and the computer program code are configured, with the at least one processor, to cause the apparatus further to
detect a type of the transport unit.

4. The apparatus of claim 3, wherein the at least one memory and the computer program code are configured, with the at least one processor, to cause the apparatus further to:
determine movement history of the mobile device on the basis of location estimation and/or tracking of the mobile device; and
detect the type of the transport unit on the basis of the movement history.

5. The apparatus of claim 3, wherein the at least one memory and the computer program code are configured, with the at least one processor, to cause the apparatus further to:
detect that a certain at least one software function is activated in the mobile device; and
detect the type of the transport unit on the basis of what at least one software function is activated.

6. The apparatus of claim 3, wherein the at least one memory and the computer program code are configured, with the at least one processor, to cause the apparatus further to:
acquire reference sensor data corresponding to a plurality of transport types;
compare the reference sensor data to a data sensed by at least one sensor of the mobile device, wherein the reference sensor data is related to the corresponding at least one sensor; and
detect the type of the transport unit on the basis of the comparison.

7. The apparatus of claim 6, wherein the reference sensor data comprises EMF data, and at least one memory and the computer program code are configured, with the at least one processor, to cause the apparatus further to:
compare the acquired set of EMF measurement results to the reference sensor data; and
detect the type of the transport unit on the basis of the comparison.

8. The apparatus of claim 6, wherein the reference sensor data comprises inertial data, and at least one memory and the computer program code are configured, with the at least one processor, to cause the apparatus further to:
compare the acquired set of inertial measurement results to the reference sensor data; and
detect the type of the transport unit on the basis of the comparison.

9. The apparatus of claim 1, wherein the at least one memory and the computer program code are configured, with the at least one processor, to cause the apparatus further to:
acquire EMF reference data indicating typical EMF data for a detected type of transport unit; and
apply the EMF reference data and the set of EMF measurement results in determining a location estimate of the mobile device, wherein the location estimate corresponds to the location in which the mobile device currently is and is used for location estimation and/or tracking of the mobile device.

10. The apparatus of claim 3, wherein the at least one memory and the computer program code are configured, with the at least one processor, to cause the apparatus further to:
determine a motion model of the mobile device on the basis of the detected type of the transport unit; and
apply the motion model in location estimation and/or tracking of the mobile device.

11. The apparatus of claim 10, wherein the at least one memory and the computer program code are configured, with the at least one processor, to cause the apparatus further to:
estimate a speed of the transport unit; and
take the estimated speed of the transport unit into account when determining the motion model of the mobile device.

12. The apparatus of claim 10, wherein the at least one memory and the computer program code are configured, with the at least one processor, to cause the apparatus further to:
determine a location estimate of the mobile device at least partly on the basis of the determined motion model, wherein the location estimate corresponds to the location in which the mobile device currently is and is used for location estimation and/or tracking of the mobile device.

13. The apparatus of claim 1, wherein the at least one memory and the computer program code are configured, with the at least one processor, to cause the apparatus further to:
detect that the mobile device is currently in an elevator, wherein the elevator is the transport unit;
estimate, on the basis of the set of EMF measurement results, the number of floors the mobile device has travelled in the elevator; and
determine a location estimate of the mobile device on the basis of the estimation.

14. The apparatus of claim 13, wherein the at least one memory and the computer program code are configured, with the at least one processor, to cause the apparatus further to:
determine the current floor number of the mobile device on the basis of the estimation representing the number of floors the mobile device travelled in the elevator; and
calibrate a elevation/altitude sensor comprised in the mobile device on the basis of the knowledge of the current floor number.

15. The apparatus of claim 1, wherein the at least one memory and the computer program code are configured, with the at least one processor, to cause the apparatus further to:
detect that the mobile device is currently in an underground subway, wherein the underground subway is the transport unit;
estimate, on the basis of the set of EMF measurement results, the number of at least one subway station the mobile device passed in the underground subway; and
determine a location estimate of the mobile device on the basis of the estimation.

16. The apparatus of claim 15, wherein the at least one memory and the computer program code are configured, with the at least one processor, to cause the apparatus further to:
identify the at least one subway station on the basis of the set of EMF measurement results and reference data representing EMF data for the at least one subway station.

17. The apparatus of claim 1, wherein the at least one memory and the computer program code are configured, with the at least one processor, to cause the apparatus further to:
detect that the mobile device is currently in a shopping cart, wherein the shopping cart is the transport unit;
detect vibrating motion of the mobile device on the basis of the set of inertial measurement results; and
estimate speed of the shopping cart at least partly on the basis of the detected vibration motion.

18. The apparatus of claim 1, wherein the at least one memory and the computer program code are configured, with the at least one processor, to cause the apparatus further to:
trigger an activation of a predefined software function with respect to the mobile device upon detecting a predetermined event, wherein the predetermined event is at least one of the following: detecting that the transport unit starts moving, detecting that the transport unit stops moving, detecting that the mobile device enters or is about to enter the transport unit, detecting that the mobile device exits the transport unit, detecting that the mobile device is currently located in the transport unit.

19. The apparatus of claim 18, wherein the detected type of the transport unit defines which software function is to be triggered.

20. The apparatus of claim 1, wherein the at least one memory and the computer program code are configured, with the at least one processor, to cause the apparatus further to:
identify the transport unit associated with each of a plurality of mobile devices;
determine the number of mobile devices in a certain, identified transport unit; and
perform analysis about how crowded the transport unit is on the basis of the determination.
